(19) United States
(12) Patent Application Publication
(10) Pub. No.: US 2023/0046303 A1
(43) Pub. Date: Feb. 16, 2023

(54) LOAD PART FOR AUTONOMOUSLY-GUIDED INDUSTRIAL TRUCK

(71) Applicant: Jungheinrich Aktiengesellschaft, Hamburg (DE)

(72) Inventors: Michael SCHÜLER, Wakendorf (DE); Marcel KRENZIN, Bad Bramstedt (DE); Arne ROTH, Hamburg (DE)

(21) Appl. No.: 17/819,377

(22) Filed: Aug. 12, 2022

(30) Foreign Application Priority Data
Aug. 16, 2021 (DE) 10 2021 121 224.3

(51) Int. Cl. B66F 9/075

(52) U.S. Cl. CPC B66F 9/0755

(57) ABSTRACT

The present invention relates to a load part (10) for an autonomously-guided industrial truck having a longitudinal direction and a width direction (B), comprising a pair of fork prongs (12a, 12b) extending substantially horizontally and arranged next to one another in the width direction (B), or a mono fork extending substantially horizontally and having two extension sections and a connecting section, and a load stop (14) connected to the pair of fork prongs (12a, 12b) or the extension sections and extending substantially in the vertical direction above the fork prongs (12a, 12b) or the mono fork. According to the invention, the load stop (14) has a cutout (22a, 22b) on at least one of its outer sides in the width direction (B) adjacent to the corresponding fork prongs (12a, 12b) or extension section. Furthermore, the present invention relates to an industrial truck equipped with such a load part.

The present invention relates to a load part for an autonomously-guided industrial truck having a longitudinal direction and a width direction, comprising a pair of fork prongs extending substantially horizontally and arranged next to one another in the width direction, or a mono fork extending substantially horizontally and having two extension sections as well as a connecting section, and a load stop connected to the fork prongs or the two extension sections and extending substantially in the vertical direction above the fork prongs or the mono fork.

Load carriages having fork prongs or a mono fork and vertical load stop are known from various types of industrial trucks. In the case of embodiments having fork prongs, the fork shape is generally selected in such a way that an inner and an outer web of the same thickness are connected to one another via a cover plate, wherein both webs in the fork root region have a connection to a supporting frame structure—for example, a direct connection to a load impact plate or a connection of the outer fork webs to roller webs. Depending upon the design of the industrial truck to be equipped with the fork prongs, the dimensions of the two webs can allow the fork prongs to be lowered by means of load arms of the industrial truck which in turn bear load wheels, so that, in the lowered state of the load part, the load arms lie between the webs of the fork prongs in order to reduce the height of the fork prongs above the driving base in this state.

In a similar manner, load carriages are known in which the outer fork web is formed thicker or stronger than the inner one, and both webs are connected either to the load impact plate or to roller webs, which contribute to the connection or guidance of the load part in a vertically-displaceable manner on the vehicle body of the corresponding industrial truck.

Embodiments having mono forks are generally used when, instead of pallets, objects such as lattice carts or rolling containers are to be transported, i.e., for example, in supermarkets or similar facilities.

In the case of autonomously-guided industrial trucks (frequently also referred to as AGV's—automated guided vehicles), load parts designed in this way have the disadvantage that scanner units placed in the corresponding vertical section of the industrial truck in front of the respective load part, when the load section is in the lowered state, can monitor a scanning region only past the load stop and the fork prongs or the mono fork, but not above them. In order to be able to detect load-side regions in industrial trucks which are equipped with the above-described load parts known from the prior art, the load part must accordingly be raised so that the corresponding scanning plane of the scanner units runs below the fork prongs or the mono fork.

However, this has two major disadvantages. On the one hand, a time-consuming lifting and lowering of the load part during entry or exit of pallets or other objects to be transported in or out is necessary, and this leads to a deterioration in the performance and operational efficiency of the corresponding industrial truck. On the other hand, however, there is also an increased risk of accidents and injury from industrial trucks equipped in this way, because such autonomously-guided vehicles are frequently used in logistics systems with mixed operation and accordingly cross the paths of other autonomously-driving vehicles and employees working in the warehouse.

Thus, if an autonomously-guided industrial truck stops abruptly in such a logistics environment and at the same time, for example, a manually-operated device with a driver's platform is driving behind said truck, there have already been numerous cases in the past that resulted in an accident and massive injuries to the operator in the region of their shins or knees because of the raised fork, whereas, if the forks were lowered further, this risk would be significantly reduced.

Accordingly, the aim of the present invention is to further develop a load part of the generic type for an autonomously-guided industrial truck in such a way that it is able to remove the disadvantages of the above-described prior art and, especially, can also be used for logistics devices with a block mounting, in which devices pallets or other objects are placed at minimum distances from the driving base of the device, and industrial trucks move between them.

In such scenarios, a corresponding vehicle should not exceed the width of a Euro pallet of approximately 800 mm, for example, and an especially narrow design of the resulting industrial truck is desired. An important measure for achieving this compact design consists in all the scanner units, which are located relatively close to the ground on the vehicle, being arranged, if possible, within the contour or the outline of the vehicle in a plan view, in order not to cause any protrusions or any widening at this point.

Because, according to new developments in the sector of autonomously-guided industrial trucks, the personal protection scanners previously already used are also to be used as navigation scanners, it has proven to be practicable in this context to set the substantially horizontally-extending scanning plane at a height of approximately 100 mm above the driving base, so that the autonomously-guided industrial truck equipped in this way can also easily recognize unloaded pallets.

In order now to be able to achieve the largest possible angular coverage of the scanning plane around the industrial truck that is to be equipped in this way with scanner units arranged within the vehicle outline at this height above the driving base, it is proposed according to the invention that the load stop of the present load part have a cutout on at least one of its outer sides in the width direction adjacent to the corresponding fork prongs or extension section. By means of this at least one cutout, it is possible for scanner units arranged within the vehicle contour to extend their field of view—which had hitherto been restricted by typical load parts—in the width direction of the corresponding industrial truck in such a way that the fork prongs or the mono fork itself can be at least partially swept over by the scanning region.

Because such types of autonomously-guided industrial trucks usually have a pair of scanning units that are symmetrically opposite in the width direction, it is also possible for the load stop of the load part according to the invention to have symmetrically-formed cutouts on its two outer sides.

Furthermore, in the load part according to the invention, in embodiments having two fork prongs arranged next to one another, these fork prongs extending in the longitudinal direction can comprise, in each case in relation to the width direction, an inner and an outer web and a cover plate which connects the two webs, wherein the respective inner web is formed with a larger cross-section than the respective outer web. In this way, the inner web can substantially assume the entire load-bearing function of the fork prongs, because, by providing the at least one cutout in the load stop in the region of the outer web, a suitable force absorption could no longer be ensured by a connection of this web to the load stop.

In particular, in the load part according to the invention, the fork prongs can each comprise a web, which is arranged on the inside in relation to the width direction, and an “L”-shaped cover plate. In this case, the outer web can be integrated into the L-shaped cover plate or it can be dispensed with entirely, because it does not have to have any connection to the load stop, but can only be connected to the cover plate, and, consequently, its supporting section is very small in this embodiment.

In principle, the provision of a cover plate would not be absolutely necessary, at least from a strength perspective, but, due to its extension in the width direction, it offers the advantage that the chamber dimension of pallets to be transported can be filled better and, thus, the corresponding pallets can, laterally, slip less. Even if the fork prongs could therefore also consist only of the absolutely necessary inner webs, this would possibly lead under some circumstances to tilting of the pallets, so that the provision of the cover plate is in any case preferred.

As already mentioned, the connection between the load stop and the two fork prongs can, especially, be present only in the region of the respective inner web, so that in such embodiments the outer web can only contribute to the inner stiffening of the corresponding fork prong.

In embodiments having a mono fork, the extension sections thereof can each be formed, at least In sections, as a web connected to the load stop, wherein the two webs are connected by means of a cover plate which forms the connecting section. In this case, the cover plate can have different shapes; for example, it can initially extend by a certain path length further in the direction of the extension sections and then form the connecting section running perpendicular thereto. In this case, transition regions can also be provided in which the cover plate runs at a respective angle to the corresponding extension section.

Because the vertical scanning field width of types of scanner units usually used for this purpose is approximately +/−25 mm around a central plane, the vertical extension of the at least one cutout can accordingly likewise be approximately 50 mm, so that the entire width of the scanning field can be freed as a result.

Furthermore, the present invention relates to an autonomously-guided industrial truck, comprising a vehicle body having at least one steered drive wheel, and a load part of the type according to the invention described above arranged in a vertically-displaceable manner.

In this case, the industrial truck can further comprise a pair of wheel arms extending in the longitudinal direction from the vehicle body, each bearing at least one load wheel, wherein the load part is arranged above the load arms.

In the manner already indicated, such an industrial truck according to the invention can comprise, on at least one side and preferably in a symmetrical arrangement on both sides in the width direction, a scanner unit having a scanning plane oriented to be substantially horizontal, wherein, in a completely lowered state of the load part, the at least one cutout thereof lies at a vertical height of the scanning plane. Thus, it is also ensured at the same time that, in this completely lowered state, the load forks of the load part lie below the scanning plane, and thus an enlarged monitoring region of the scanner unit is achieved by the fork prongs being able to be “scanned” by the scanner units.

For example, in an embodiment in which the scanning plane lies at a vertical height of approximately 100 mm above a driving base, a fork height in the fully-lowered state can be approximately 75 mm. Because of this horizontal arrangement of the sections of the load part and the fork prongs, the above-indicated detection of pallets in the lowered state of the load part can take place in the desired manner.

Furthermore, the industrial truck according to the invention can comprise a control unit which is configured to control a vertical displacement of the load part in such a way that, in a movement state of the industrial truck with the load part raised, it always is located at at least one predetermined height difference above the scanning plane. Thus, in a ready-to-drive and loaded state of the industrial truck, in which the industrial truck carries, for example, a pallet on the raised load part, it is ensured that, in this case, the scanning plane is below the fork prongs and the pallet, and the detection of the surroundings of the industrial truck can likewise take place in the desired and trouble-free manner below the load part and the load carried thereon.

Further features and advantages of the present invention will become even more apparent from the following description of an embodiment, when viewed together with the accompanying figures. These show, In detail:

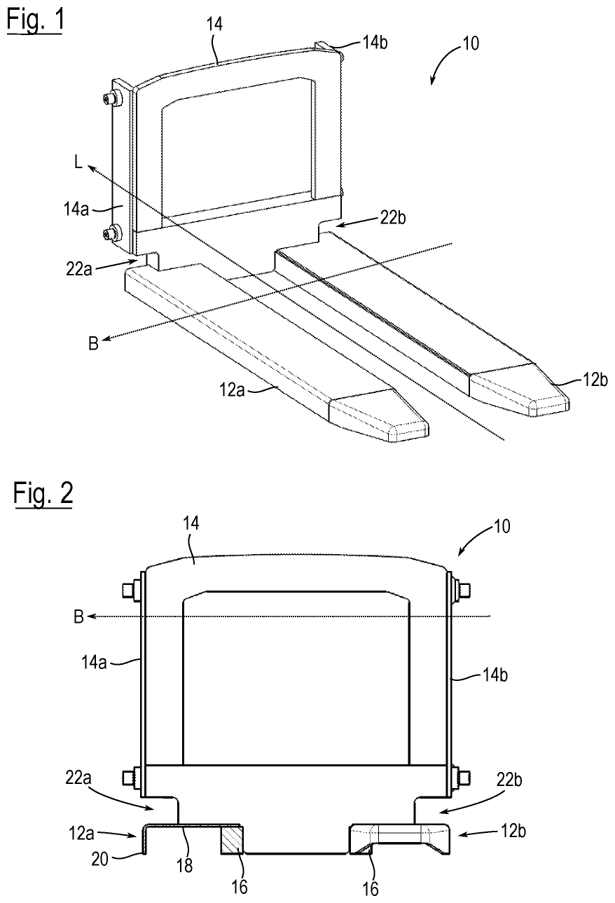

FIG. 1 an isometric view of a load part according to the invention for an autonomously-guided industrial truck;

FIG. 2 the load part from FIG. 1 in a front view,

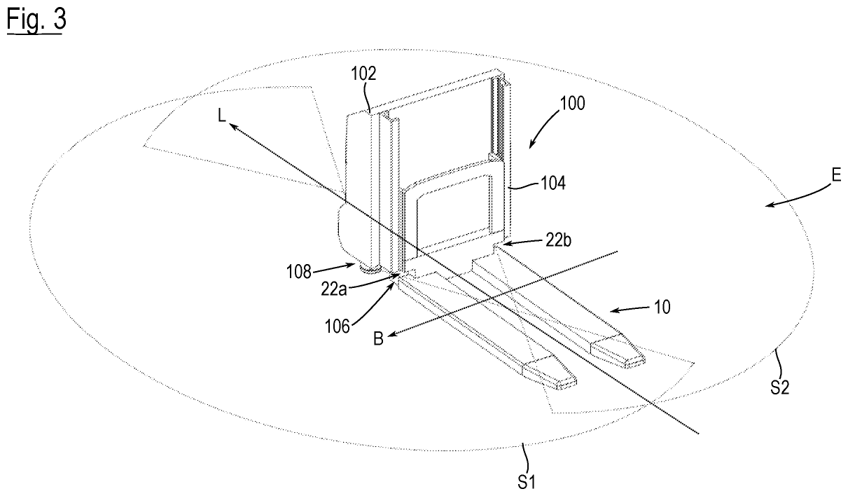

FIG. 3 a simplified view of an industrial truck equipped with such a load part in an isometric view, and

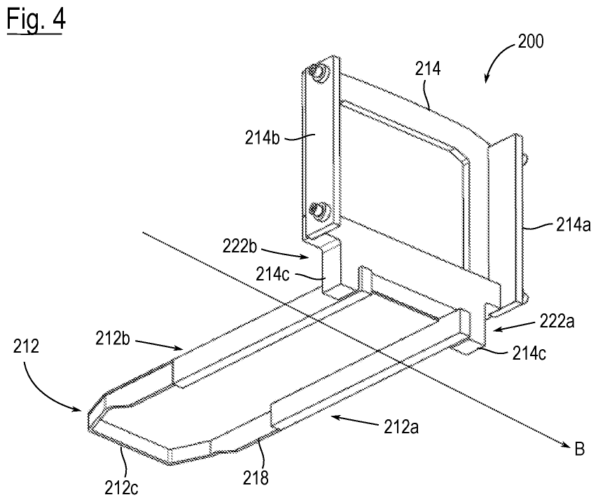

FIG. 4 an alternative embodiment of a load part according to the invention in an isometric view from below.

In FIG. 1, a load part according to the invention for an autonomously-guided industrial truck is initially shown in an isometric view and is generally denoted by reference sign 10. The load part 10 here comprises a pair of fork prongs 12a and 12b extending substantially horizontally in a longitudinal direction L and arranged next to one another in a width direction B, as well as a load stop 14 connected to the pair of fork prongs 12a and 12b and extending substantially in the vertical direction above the fork prongs 12, 12b.

In this case, the load stop 14 is provided on its two sides in the width direction B with respective profiles 14a and 14b, which enables a coupling to a vehicle body 102, which is illustrated only in FIG. 3, of an industrial truck 100 to be equipped with the load part 10 in the manner of roller webs.

As can be seen especially from the rear view of FIG. 2, the two fork prongs 12a and 12b are each formed with an inner web 16, which is connected to the load stop 14 in the region of the fork root of the respective fork 12a, 12b. Furthermore, an “L”-shaped cover plate 18 initially extends outwards from the respective inner web 16 in the width direction B and then vertically downwards, wherein the vertically-extending part thereof forms an outer web 20. In this way, the coupling of the inner web 16 having a larger cross-section to the load stop 14 achieves sufficient rigidity of the connection between the fork prongs 12a, 12b and the load stop 14, while the cover plate 18 is used for slip-free and tilt-free carrying of pallets, and the outer web 20 effects only an inner stiffening of the respective fork prong 12a, 12b. Furthermore, this embodiment of the two fork prongs 12a and 12b allows the possibility of lowering the fork prongs via load arms of a corresponding industrial truck, so that, in the lowered state of the load part, the load arms lie between the webs of the fork prongs in order to reduce the height of the fork prongs above the driving base in this state.

As can be seen both in FIG. 1 and in FIG. 2, the load stop 14 has two cutouts 22a and 22b on its two outer sides in the width direction B, respectively adjacent to the corresponding fork prongs 12a and 12b, the function of which is explained in more detail further below with reference to FIG. 3. In one embodiment, the two cutouts 22a and 22b can have, for example, a vertical extension of 50 mm and an extension in the width direction B of 50 to 150 mm.

FIG. 3, lastly, shows, in a simplified manner, an autonomously-guided industrial truck 100 according to the invention, which comprises the load part 10 from FIGS. 1 and 2 arranged in a vertically-displaceable manner by means of roller webs 104, which in turn are associated with the vehicle body 102 of the industrial truck 100. In the state shown in FIG. 3, the load part 10 is lowered completely vertically and rests directly on a pair of wheel arms 106 extending from the vehicle body 102 that are largely concealed in the illustration of FIG. 3. The load wheels supported by the wheel arms 106, like the at least one steered drive wheel and any support wheels to be provided, are omitted in the simplified illustration of FIG. 3 for reasons of clarity.

On its outer sides in the width direction B, the industrial truck 100 comprises scanning units 108 which are symmetrically opposite one another and from which only one can also be seen in FIG. 3, while the other is concealed. Together, the respective scanning regions S1 and S2 of the two scanner units 108 form a substantially horizontally-aligned scanning plane E.

In the embodiment according to the invention of an autonomously-guided industrial truck shown in FIG. 3, the scanning plane E in the fully-lowered state of the load part 10 is situated above the two forks 12a and 12b and in the region of the cutouts 22a and 22b of the load part 10. Thus, as can be clearly seen in FIG. 3 on the basis of the contours of the scanning regions S1 and S2, an at least partial coverage of the region above the two forks 12a and 12b, as well as a nearly complete surrounding view outside the outer contours of the industrial truck 100, can be achieved by the scanner units 108. For this purpose, the vertical extensions of the two sections 22a and 22b are matched to the vertical width of the scanning plane E and can, for example, be approximately 50 mm. Accordingly, the upper sides of the forks 12a and 12b are at a fork height of approximately 75 mm above the driving base, so that conventional Euro pallets can also be detected by the scanner units 108 in the surroundings of the industrial truck 100.

Furthermore, the industrial truck 100 can be configured, in a loaded state—especially when a pallet is gripped and raised by the load part 10—to always lift a pallet far enough that the scanning plane E extends completely below the load part and the carried pallet, and thus a problem-free surrounding view is again possible, because the two scanning fields S1 and S2 cover the region around the industrial truck 100 in the same way as in the state from FIG. 3.

Furthermore, by lowering the forks 12a and 12b, the stated fork height of approximately 75 mm in the unloaded state can be minimized, because the forks now no longer extend in this state to a height at which human workers could thus injure themselves in the region of their shins or knees in the event of a collision.

Finally, FIG. 4 shows an alternative embodiment of a load part according to the invention in an isometric view obliquely from below, which is generally denoted by the reference sign 200 and which could be used in the industrial truck 100 in a similar manner to the load part 10 from FIGS. 1 and 2. In this case, components of the load part 200, which correspond to those from the embodiment of FIGS. 1 and 2 or fulfill an equivalent function, are each denoted by the same reference sign, increased by 200, and the explanation thereof is partially omitted in the following with reference to the above explanation of the corresponding components in FIGS. 1 and 2.

In contrast to the embodiment shown in FIGS. 1 and 2 with the two fork prongs 12a and 12b, the load part 200 comprises a mono fork 212 with two extension sections 212a and 212b, as well as a connecting section 212c connecting the extension sections 212a and 212b at a front end thereof. As a result of this construction, an industrial truck with the load part 200 is generally used when objects such as lattice carts or rolling containers are to be transported, i.e., for example, in supermarkets or similar installations.

In the embodiment shown in FIG. 4, the extension sections 212a and 212b of the mono fork 212 are each formed in sections as a web connected to the load stop 214, wherein the two webs are connected by means of a cover plate 218, which in turn forms the connecting section 212c. In this case, however, the cover plate 218 extends, starting from the extension sections 212a and 212b, initially by a stretch in the same direction as these, before, after an in each case slightly angled transition region, the connecting section 212c is ultimately connected.

Also in the region of the load stop 214, a slight modification has been made compared to the embodiment from FIGS. 1 and 2 and results from the fact that the cover plate 218 does not extend beyond the webs in the width direction B to the outside. Instead, extensions 214c are provided outside the webs in the width direction B, which extensions delimit the cutouts 222a and 222b and extend in the vertical direction up to the underside of the webs. Thus, in this embodiment, the two extension sections 212a and 212b do not directly adjoin the cutouts 222a and 222b, but are still to be regarded as adjacent to them in the sense of the present invention.

In the embodiment of FIG. 4, these cutouts 222a and 222b fulfill the same function as the cutouts 22a and 22b in the embodiment from FIG. 1 and FIG. 2, so that the above-described improvements with regard to a scanning region to be covered in an industrial truck equipped therewith can also be achieved with the load part 200.

1. Load part (10; 200) for an autonomously-guided industrial truck (100) having a longitudinal direction (L) and a width direction (B), comprising:
a pair of fork prongs (12a, 12b) extending substantially horizontally and arranged next to each other in the width direction (B); or
a mono fork (212) extending substantially horizontally and having two extension sections (212a, 212b) as well as a connecting section (212c), and
a load stop (14; 214) connected to the pair of fork prongs (12a, 12b) or to the two extension sections (212a, 212b) and extending substantially in the vertical direction above the fork prongs (12a, 12b) or the mono fork (212),
characterized in that the load stop (14; 214) has a cutout (22a, 22b; 222a, 222b) on at least one of its outer sides in the width direction (B) adjacent to the corresponding fork prongs (12a, 12b) or extension section (212a, 212b).

2. Load part (10; 200) according to claim 1,
characterized in that the load stop (14; 214) on its two outer sides has cutouts (22a, 22b; 222a, 222b) formed symmetrically in the width direction (B).

3. Load part (10) according to one of the preceding claims,
characterized in that the fork prongs (12a, 12b) each comprise, in relation to the width direction (B), an inner (16) and an outer (20) web as well as a cover plate (18) connecting the two webs (16, 20),
wherein the respective inner web (16) is formed with a larger cross-section than the respective outer web (20).

4. Load part (10) according to one of the preceding claims,
characterized in that the fork prongs (12a, 12b) each comprise a web (16), arranged on the inside in relation to the width direction (B), and an “L”-shaped cover plate (18).

5. Load part (10) according to one of claims 3 and 4,
characterized in that the connection between the load stop (14) and the fork prongs (12a, 12b) is present only in the region of the respective inner web (16).

6. Load part (200) according to one of claims 1 and 2,
characterized in that the extension sections (212a, 212b) of the mono fork (212) are each formed at least in sections as a web connected to the load stop (214), wherein the two webs are connected by means of a cover plate (218) which forms the connecting section (212c).

7. Load part (10; 200) according to one of the preceding claims, characterized in that the vertical extension of the at least one cutout (22a, 22b; 222a, 222b) is approximately 50 mm.

8. Autonomously-guided industrial truck (100) comprising:
a vehicle body (102) having at least one steered drive wheel; and
a load part (10; 200) according to one of the preceding claims arranged in a vertically-displaceable manner.

9. Industrial truck (100) according to the preceding claim,
characterized in that it further comprises a pair of wheel arms (106) extending from the vehicle body (102), each carrying at least one load wheel; and
the load part (10; 200) is arranged above the load arms (106).

10. Industrial truck (100) according to one of claims 8 and 9,
characterized in that, on at least one side and preferably in a symmetrical arrangement on both sides in the width direction (B), it comprises a scanner unit (108) having a substantially horizontally-aligned scanning plane (E),
wherein the at least one cutout of the load part (10; 200) is at a vertical height of the scanning plane (E) when said load part is in a fully-lowered state.

11. Industrial truck (100) according to the preceding claim,
characterized in that the scanning plane (E) is at a vertical height of approximately 100 mm above a driving base, and a fork height in the fully-lowered state is approximately 75 mm.

12. Industrial truck (100) according to one of claims 10 and 11,
characterized in that it further comprises a control unit which is configured to control a vertical displacement of the load part (10; 200) in such a way that, in a movement state of the industrial truck (100) with the load part (10; 200) raised, said load part is always located at at least a predetermined height difference above the scanning plane (E).
